(19) United States
(12) Patent Application Publication
(10) Pub. No.: US 2006/0120276 A1
(43) Pub. Date: Jun. 8, 2006

(54) Apparatus for protecting low/high order traffic boards in a synchronous digital hierarchy transmission device

(75) Inventors: Gang You, Shanghai (TW); Jin Yao, Shanghai (TW)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/206,773

(22) Filed: Aug. 19, 2005

(30) Foreign Application Priority Data
Nov. 19, 2004 (CN) 200410084377.6

(51) Int. Cl. H04L 12/56; H04J 1/16; H04L 12/28; H04J 3/14

(52) U.S. Cl. 370/216; 370/419

(57) ABSTRACT

The present invention relates to an apparatus for protecting low/high order traffic boards in a synchronous digital hierarchy transmission device, comprising a spare low/high order traffic board arranged at said low/high order traffic region; a set of low/high order protection buses, arranged in said backboard of said synchronous digital hierarchy transmission device and respectively connected to said low/high order port board, for enabling each low/high order port board to receive a signal transmitted via said low/high order protection buses; a low/high order protection board, arranged at said port region and plugged in a slot of said low/high order port board, for connecting said low/high order protection buses to buses of said spare low/high order traffic board. Without increasing complexity of a system, the invention provides a set of low/high order protection buses. Redundant protection for the low/high order traffic board is achieved by the low/high order protection board so as to enhance reliability of the system. In addition, the low/high order protection boards can be plugged to any slot of the port region to increase flexibility of the system. The invention provides redundant protection for the traffic boards in a low-cost and simple manner.

### FIELD OF THE INVENTION

The present invention relates to protection technique for protecting low/high order traffic boards in a synchronous digital hierarchy transmission device.

### BACKGROUND OF THE ART

At present, synchronous digital hierarchy (SDH) transmission devices have been heavily applied in an optical transmission network. SDH transmission devices are equipped with standard optical interfaces, utilize synchronous multiplex and can be easily managed and maintained. Hence, they have already been substantially substituted for plesiochronous digital hierarchy transmission devices.

In a synchronous digital hierarchy transmission device, the main function of low order traffic boards (herein referring to E1 traffic boards, E1 interface is a primary-group-line interface with a rate of 2.048 Mb/s in a plesiochronous digital hierarchy, belonging to Europe system) is to perform mapping E1 signals to SDH frames and demapping thereof. The E1 interface can be directly connected to a switch, so low order traffic boards are often in the majority in a configuration of the SDH transmission device. Once a fault occurs in a low order traffic board, smoothness of low order channel traffic will be affected, namely transmission E1 signals in SDH frames. Thus, operators often want to provide redundant protection for it. That is to say, when a fault occurs in a certain low order traffic board, there needs a protection board which take the place of the low order traffic board in fault for transmission of E1 signals.

As such, within SDH transmission device, once a fault occurs in a high order traffic board (for example, E3 traffic board, E3 interface is a tertiary-group-line interface with a rate of 34.386 Mb/s in a plesiochronous digital hierarchy, belonging to Europe system), smoothness of high order channel traffic will be affected. Operators hope that there will be an effective way for its redundant protection as well.

In development of SDH transmission devices, a problem to be solved is how to design a protection method for effective protection for low/high order traffic boards without increasing complexity of the system as well as the overall cost.

### SUMMARY OF THE INVENTION

For the need of redundant protection for the low/high order traffic boards in a SDH transmission device, the present invention is directed to providing an apparatus for protecting low/high order traffic boards by which efficient protection for low/high order traffic boards is achieved without increasing complexity of a system and cost.

In order to achieve the above object, the technical solution is as follows: an apparatus for protecting low order traffic boards in a synchronous digital hierarchy transmission device, a backboard of said synchronous digital hierarchy transmission device comprising a port region composed of a plurality of port boards and a traffic region composed of a plurality of low order traffic boards which one-to-one correspond to said plurality of port boards, said protection apparatus connected to said synchronous digital hierarchy transmission device, comprising: a spare low order traffic board arranged at said low order traffic region; a set of low order protection buses, arranged in said backboard of said synchronous digital hierarchy transmission device and respectively connected to said low order port board, for enabling each low order port board to receive a signal transmitted via said low order protection buses; a low order protection board, arranged at said port region and plugged in a slot of said low order port board, for connecting said low order protection buses to buses of said spare low order traffic board.

In order to achieve the above object, the technical solution is as follows: an apparatus for protecting high order traffic boards in a synchronous digital hierarchy transmission device, a backboard of said synchronous digital hierarchy transmission device comprising a port region composed of a plurality of port boards and a traffic region composed of a plurality of high order traffic boards which one-to-one correspond to said plurality of port boards, said protection apparatus connected to said synchronous digital hierarchy transmission device, comprising: a spare high order traffic board arranged at said high order traffic region; a set of high order protection buses, arranged in said backboard of said synchronous digital hierarchy transmission device and respectively connected to said high order port board, for enabling each high order port board to receive a signal transmitted via said high order protection buses; a high order protection board, arranged at said port region and plugged in a slot of said high order port board, for connecting said high order protection buses to buses of said spare high order traffic board.

By means of the above technical solutions, i.e. sufficiently considering not increasing complexity of a system, a set of low/high order protection buses are provided in the design, redundant protection for the low/high order traffic board is achieved by a low/high order protection board with simple design so as to enhance reliability of the system. In addition, the low/high order protection boards can be plugged to any slot of the port region to increase flexibility of the system. The invention provides redundant protection for the traffic boards in a low-cost and simple manner.

### BRIEF DESCRIPTION OF THE DRAWINGS

FIG. 1 is a structural block diagram of an apparatus for protecting low order traffic boards in a SDH transmission device.

### PREFERRED EMBODIMENT

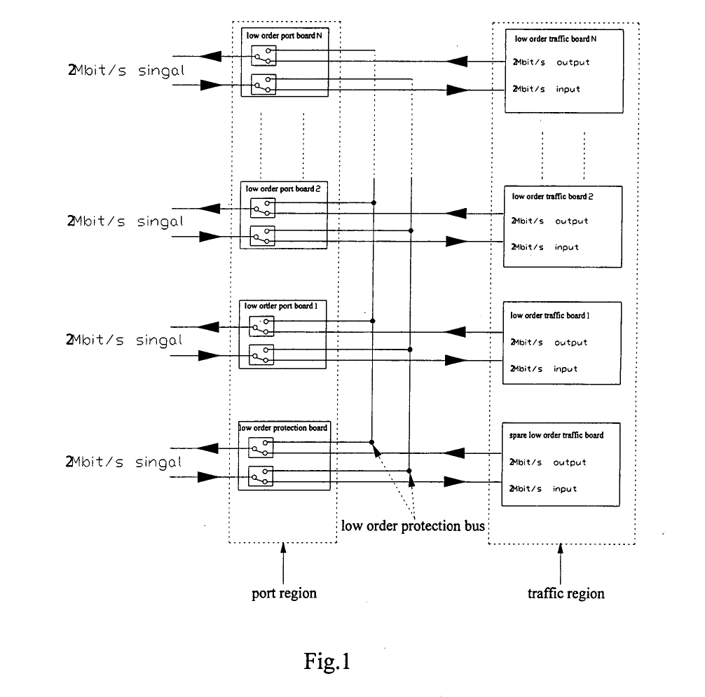

FIG. 1 illustrates a connecting relationship between low order traffic boards and low order port boards. Generally, a plurality of low order traffic boards and low order port boards can be plugged in a sub-frame of a transmission device. In a normal condition, each low order traffic board transmits E1 signals with 2.048 Mb/s to a respective low order port board and the low order port boards provide outside physical interfaces for transmitting and receiving E1 signals. As show in the FIGURE, low order traffic board 1 is connected to low order port board 1, low order traffic board 2 is connected to low order port board 2, and low order traffic board N is connected to low order port board N. Each low order port board can receive E1 signals of a spare low order traffic board from a low order protection board via a low order protection bus besides low order E1 signals from a respective low order traffic board.

When redundant protection for a low order traffic board is needed, a spare low order traffic board is plugged in any slot in a traffic region of the device (the spare low order traffic board and the operative low order traffic board are completely in common use) and a dedicated low order protection board is plugged in a port region corresponding to a slot of the spare low order traffic board.

Assuming that a fault occurs in low order traffic board N, the spare low order traffic board goes into operation at this point and the E1 signals transmitted by the spare low order traffic board are forwarded on the low order protection bus via the low order protection board. For low order port board N, it has detected a fault occurred in the E1 signals from low order traffic board N and switches to the low order protection bus to receive the E1 signals transmitted by the spare low order traffic board. In this way, the spare low order traffic board substantially takes the place of low order traffic board N for operation, and thus protection for low order traffic board in fault will be achieved.

In the design of this solution, low order protection board can be plugged in any slot of the low order port region and the main function thereof is to connect the low order protection bus to bus of the spare low order traffic board. Such a design for the low order protection board is very simple and at low cost. That is, when a fault occurs in a low order traffic board in the device, the low order E1 signals is backwarded to the spare low order traffic board via the low order protection board, so that protection for the low order traffic board in fault is achieved.

When at most N operative low order traffic boards can be plugged in the system, this solution will achieve redundant protection for low order traffic board N+1.

As such, an apparatus for protecting high order traffic boards in a synchronous digital hierarchy transmission device is similar to the above apparatus for protecting high order traffic boards, and comprises a spare high order traffic board arranged at said high order traffic region, a set of high order protection buses, arranged in said backboard of said synchronous digital hierarchy transmission device and respectively connected to said high order port board, for enabling each high order port board to receive a signal transmitted via said high order protection buses, and a high order protection board, arranged at said port region and plugged in a slot of said high order port board, for connecting said high order protection buses to buses of said spare high order traffic board. The high order protection board can be plugged in any slot of the port region of the device for achievement of redundant protection for high order traffic board N+1.

The protection technique for the low/high order traffic boards of the present invention is also suitable for protection design of other traffic boards which need to be protected in the transmission device.

The above embodiments of the present invention have been presented by way of example only, and not limitation. It should be noted that various changes and modifications could be made by those skilled in the art herein without departing from the spirit and scope of the invention. Therefore, all equivalent technical solutions should belong to the scope of the present invention which should be limited by the attached claims.

1. An apparatus for protecting low order traffic boards in a synchronous digital hierarchy transmission device, a backboard of said synchronous digital hierarchy transmission device comprising a port region composed of a plurality of port boards and a traffic region composed of a plurality of low order traffic boards which one-to-one correspond to said plurality of port boards, characterized in that said protection apparatus connected to said synchronous digital hierarchy transmission device, comprising:
a spare low order traffic board arranged at said low order traffic region;
a set of low order protection buses, arranged in said backboard of said synchronous digital hierarchy transmission device and respectively connected to said low order port board, for enabling each low order port board to receive a signal transmitted via said low order protection buses;
a low order protection board, arranged at said port region and plugged in a slot of said low order port board, for connecting said low order protection buses to buses of said spare low order traffic board.

2. An apparatus for protecting high order traffic boards in a synchronous digital hierarchy transmission device, characterized in that a backboard of said synchronous digital hierarchy transmission device comprising a port region composed of a plurality of port boards and a traffic region composed of a plurality of high order traffic boards which one-to-one correspond to said plurality of port boards, said protection apparatus connected to said synchronous digital hierarchy transmission device, comprising:
a spare high order traffic board arranged at said high order traffic region;
a set of high order protection buses, arranged in said backboard of said synchronous digital hierarchy transmission device and respectively connected to said high order port board, for enabling each high order port board to receive a signal transmitted via said high order protection buses;
a high order protection board, arranged at said port region and plugged in a slot of said high order port board, for connecting said high order protection buses to buses of said spare high order traffic board.
